(19) United States
(12) Patent Application Publication
(10) Pub. No.: US 2012/0296691 A1
(43) Pub. Date: Nov. 22, 2012

(54) System and Method for Designing and Executing Subject-State Engine Workflows

(76) Inventors: Benoit Ethier, Rosemere (CA); Steve Mathieu, Ste-Julie (CA); Alain Paquin, Repentigny (CA)

(21) Appl. No.: 13/522,813

(22) PCT Filed: Jan. 19, 2011
(86) PCT No.: PCT/CA11/00069

§ 371 Date: Jul. 18, 2012

Related U.S. Application Data
(60) Provisional application No. 61/296,279, filed on Jan. 19, 2010.

(51) Int. Cl. G06Q 10/06

(52) U.S. Cl. 705/7.27

(57) ABSTRACT

The present invention generally relates to systems and methods for providing and building dynamic and adaptable workflows. The present invention moves away from static workflows, such as marketing campaigns that focus on a brand or product, and allows workflows that are generic to a class of subjects (e.g. a consumer, a work order, an automobile, etc.), and permits the workflows to be tailored to the specific subject type and its states. The present invention provides tools for building and simulating one or more scenarios that address a specific subject prior to its launch, and also provides tools for executing and monitoring the workflows according to the one or more scenarios. The present invention provides a way to interface with several external services and data intelligently in order to establish an efficient environment with multiple workflows for each subject type.

### CROSS-REFERENCE TO RELATED APPLICATIONS

The present application claims the benefits of priority of commonly assigned U.S. Provisional Patent Application No. 61/296,279, entitled “System and Method for Providing a Dynamic, Scalable and Adaptable Marketing Ecosystem”, and filed at the United States Patent and Trademark Office on Jan. 19, 2010; the content of which is incorporated herein by reference.

### FIELD OF THE INVENTION

The present invention generally relates to the field of systems and methods of workflow management and more particularly relates to systems and methods for marketing and process automation.

### BACKGROUND OF THE INVENTION

The advent of the Internet has changed the marketing landscape in a profound way. Using the field of marketing as a specific example, today's consumers are exposed to a tremendous amount of marketing pressure. On a daily basis, they are exposed to several thousand irrelevant marketing messages. This makes them less receptive to marketing messages in general, particularly mass media messages. In today's market, it is the consumer who dictates the pace and sequence of the sales cycle.

In order to determine when and how to best communicate with consumers, marketers have resorted to data warehouses, Customer Relationship Management (“CRM”) systems, Lead Management (“LM”) solutions, and a host of Marketing Automation (“MA”) solutions.

It is said that data is knowledge and knowledge is power. From a marketing point of view, data is the power to know who one is talking to, to know when to talk to them, and to say the right message using the right media. Armed with this knowledge, most software vendors in the CRM, Sales Force Automation (“SFA”), Enterprise Marketing Management (“EMM”) and MA arena have adopted basically the same approach, built on the premise that “if we host his data, we own the customer”. Typically the first step in implementing such a solution is to centralize the database. In a sense, this Independent Software Vendor (“ISV”) strategy is very efficient. Indeed, if a marketer invests massively into a corporate solution to create and import all their data under a single ISV control, there is a strong chance that this marketer will be locked in with this particular ISV. The switching costs are often prohibitive.

Against this background, there is a need for a novel solution where centralized data will not be necessary and which can be customized and tailored by the user.

### SUMMARY OF THE INVENTION

Basically, the present invention generally comprises computer-based tools for designing and executing subject-state-based multi-level conditional workflows.

More particularly, the present invention generally allows a user to design and create customized subject-state-based workflows, hereinafter referred to as scenarios, and to execute these scenarios in a distributed computer environment.

In that sense, the present invention allows the user to define scenarios (i.e. subject-state-based workflows) in which the user define the subject, the states, the events, the conditional logic interconnecting the states (i.e. the conditions), the actions to be initiated in response to events and according to the conditional logic.

In these scenarios, the state of a subject is the position, defined by the user, in which the subject is. A scenario typically comprises several states which are interconnected via conditional logic. Hence, the present invention allows the user to model, connect and execute conditional logic flows in response to events or triggers associated with the state of a subject.

Understandably, in the present invention, a subject is a general and broad concept and generally comprises any entity that can have different states in a workflow. Hence, a subject can be, for instance, a customer, a vehicle, a house, a work order, etc.

According to the conditional logic of a scenario and of its various states, the present invention is adapted to dynamically turn on and off event detection as the state of a subject changes. Also, an event that is conditionally true may modify one or more attributes of the subject, may cause the issuance one or more actions with external systems, typically via the exchange of simple XML tickets, and may change the state of the subject in one or more other scenarios that make up the subject's ecosystem.

The present invention is typically comprised of methods and processes implemented on one or more computer systems which have access, among other things, to external distributed computer networks (e.g. the Internet) and external networked resources. For the sake of simplicity, the combination of computerized methods and processes, of the computer systems, and of other components, will be referred to below as the system.

As indicated above, a system in accordance with the present invention is particularly adapted to operate in a distributed data and system environment. Because the system communicates with external systems and/or resources, typically via simple XML tickets, it is possible for the user to escape from the grips of centralized ISV strategy. As the system can interact with external and third party systems and/or resources, the user is free to choose best of breed solutions, systems and resources, and to combine them into a custom workflow solution.

The approach of the present invention is different from an ISV. Indeed, the focus of the present invention is not to centralize and store data in order to enable workflows. Rather, through its asynchronous data exchange capabilities, the system in accordance with the present invention allows conditional workflows to operate in a distributed data and operating environment.

Furthermore, by providing the user the ability to design his own scenarios according to used-defined conditional logic and courses of actions, the system of the present invention allows the user to design subject-state workflows which are tailored and customized to his particular needs. Such benefits are not provided by prior art solutions.

Other and further objects and advantages of the present invention will be obvious upon an understanding of the illustrative embodiments about to be described or will be indicated in the appended claims, and various advantages not referred to herein will occur to one skilled in the art upon employment of the invention in practice. The features of the present invention which are believed to be novel are set forth with particularity in the appended claims.

### BRIEF DESCRIPTION OF THE DRAWINGS

The above and other objects, features and advantages of the invention will become more readily apparent from the following description, reference being made to the accompanying drawings in which:

FIG. 1 is a diagram of an example of a state-based workflow hierarchy in accordance with the principles of the present invention.

FIG. 2a is a diagram of an example of a scenario, the focus being on the beginning state and its associated event.

FIG. 2b is a diagram of an example of a scenario, the focus being on the conditions.

FIG. 2c is a diagram of an example of a scenario, the focus being on the action.

FIG. 2d is a diagram of an example of a scenario, the focus being on the end state.

FIG. 3 is a schematic diagram of the components of a system in accordance with the principles of the present invention.

FIGS. 4 and 5 are screenshots of examples of design screens in accordance with the principles of the present invention.

FIGS. 6 and 7 are screenshots of examples of ecosystem configuration windows in accordance with the principles of the present invention.

FIG. 8 is a screenshot of an example of a rule configuration window in accordance with the principles of the present invention.

FIG. 9 is a screenshot of an example of an action configuration window in accordance with the principles of the present invention.

### DETAILED DESCRIPTION OF THE PREFERRED EMBODIMENT

Novel systems and methods for designing and executing subject-state-based workflows will be described hereinafter. Although the invention is described in terms of specific illustrative embodiments, it is to be understood that the embodiments described herein are by way of example only and that the scope of the invention is not intended to be limited thereby.

The present embodiment of the present invention is typically comprised of methods and processes implemented on one or more computer systems which have access to one or more external distributed computer networks (e.g. the Internet) and to external networked resources (e.g. networked databases). Again, for the sake of simplicity, the combination of computerized methods and processes, of computer systems, and/or of other components, will be simply referred as the “system” in the following description. However, the skilled addressee will understand that the present invention is not limited to the physical system on which the methods and processes are implemented.

In order to contextualize the present invention, a number of concepts will be defined. In addition, the present embodiment will be described and explained in the context of marketing and with marketers as primary users. Still, the present invention understandably extends to any discipline and/or application involving subject-state-based workflows with distributed data capture, data stores (i.e. databases) and action engines (e.g. email service provider). In other words, the present invention could just as easily be applied to concepts such as the life cycle of a customer order as it flows from order to cash. Such a process typically includes various side subjects, such as purchase orders and invoices, each with their own life cycle.

What follows is a short statement describing the differences between a brand ecosystem and a subject ecosystem for a given product. This will help in understanding the fundamental philosophical basis of the present invention.

A brand ecosystem is composed of all subjects that can use a particular product (in a large sense of word). Think of all the users of Coca-Cola® for example. A subject ecosystem, on the other hand, is composed of all brands used by a particular subject (e.g. the consumer drinks soft drink, juice, milk, beer, etc.).

In a brand ecosystem, the marketer will typically determine the best time to send out a message according to the brand's requirement. For instance, back-to-school specials, autumn winter tire promotions, etc. However, even the best crafted marketing message is wasted on a consumer who has no kids or has purchased winter tires within a given time frame (e.g. two years or less). The consumer is not currently in a state where he is receptive to a back-to-school or winter tire marketing message.

On the other hand, a subject ecosystem views all events, conditions and actions from the view of the state of the subject. The state of the subject will direct the appropriate message and timing of the response to any pertinent event. For example, if he purchased his tires two years ago, now may be a good time to start a tire promotion cascade. The subject ecosystem allows the marketer to track and react to customers individually according to their timing and not to the timing of the brand.

Up to now, prior art MA tools have focused on brand ecosystems. The purpose of MA solutions is to send the best personalized message based on consumer profiles and behavior. Many MA solutions perform this task by applying complex rules based on the customer's profile and past behavior and segmenting the contacts accordingly. Prior art MA tools are often bundled with CRM, Business Intelligence, and email functionality, either internally or through third party integration. Prior art MA tools typically consist of scripts, wizards and templates that guide the user through the steps necessary to build and use the solutions, including contact management, campaign management and reporting. Some prior art MA solutions offer visual design tools to map out linear data flows that translate into MA script that is functional in the bundled application. This approach allows for batched segmented personalized messaging. However, prior art MA tools neglect the current state of the recipient, that is to say is the recipient receptive to receive the message (e.g. Did the contact visit the site yesterday vs. last week? Does he open his emails?).

In the context of the present invention, the actions are subservient to the state of the subject. In other words, the system takes into consideration the current state of the subject in order to issue the proper action. This brings a new dimension to marketing communications automation and to workflow management in general. Indeed, instead of sending personalized messages when the brand owner is ready to talk (e.g. every Wednesday, back-to-school, etc.), the system considers the state of the subject as events occur, and triggers personalized marketing activities (i.e. actions) and state changes according to the scenario rules. This approach enables near real-time personalization of messages, channel selection, timing and data flow in response to an event according to the current state of the subject, a state that can change at any time due any number of events not related to the current flow.

Also, a marketing campaign is generally based on an established workflow of events and actions that take place between a defined start date and end date. The same can be said about most workflows. The campaign workflow identifies the launch, operation and tracking of the campaign. It is linear in nature and relies on waves of communications according to a pre-set schedule. Campaigns may consist of multiple steps and can incorporate different media and response mechanisms; however they are all based on a fixed time table. Campaign results are measured by conversions occurring while the campaign is active. If a subject does not follow the predicted workflow then exceptions occur.

A marketing ecosystem recognizes that consumer behavior can be random and that consumers can be in multiple states at one time according to numerous different factors depending on the objectives of the marketer. Nor do consumers end at a fixed point in time. The subject has its own life cycle.

Subjects are typically engaged in multiple activities. They browse the web, they open emails, they chat, they buy online, they use loyalty cards, etc. A marketing ecosystem permits the marketer to model scenarios to respond to events from each of these channels, and to assemble and relate these scenarios by customer state. This allows the marketer to build complex and rich environments where they can develop strategies and tactics to respond to changes in customer states, and to encourage them to move to a desired state.

Furthermore, event or trigger marketing focuses on launching a communication (i.e. action) sequence in response to an event. That event could be a contact subscribing to a newsletter or the launch of a new brand of mouthwash. Once the trigger is detected, the sequence starts. In business to business (“B2B”) environment, it usually begins with an outbound campaign followed by lead scoring, follow-on communications, and hand-off of qualified leads to sales is the aim. In a business to consumer (“B2C”) environment, the goal is customer profile acquisition, conversion and retention through drive to web campaigns, newsletters, subscriptions, email, ecommerce and social media. All of these trigger mechanisms involve decision trees. In a simple example such as a double opt-in email acquisition process, the decision tree needs to consider: 1) opt in followed by confirmation; 2) opt in only, no confirmation after 3 days; 3) opt-in and no confirmation after 5 days. Sophisticated multi-step and multi-channel scenarios quickly overwhelm the user's ability to follow the complexities of the resulting decision tree.

However, Subject-State Marketing (“SSM”), as in an application of the present invention, focuses on moving customers to a desired state, ideally to a VIP state. This is done by describing marketing scenarios around each possible customer state. As there are a finite number of states to deal with, SSM greatly simplifies the design of one-to-one marketing strategy. In the double opt-in example, above, SSM only needs to consider an unconfirmed state and a confirmed state. As all events are local to a state, any non-relevant event do not need to be considered. By avoiding a decision tree paradigm, SSM allows the marketer to focus on a subject state and determine the response to detectable relevant events. Scenarios that focus on sub-states allow for the design of complex marketing behavior and programs that respond in near real-time according to the subject's time table.

Hence, the present invention, and the present embodiment thereof, can be seen as a paradigm shift with respect to prior art workflow management tools (e.g. MA tools). Indeed, whereas prior art workflow management tools were typically linear and based on timelines, the present invention is asynchronous and based on the state of the subject.

Before describing the present embodiment of the system in accordance with the present invention, and its several functionalities, it is important to understand some basic concepts, some of which having already being introduced.

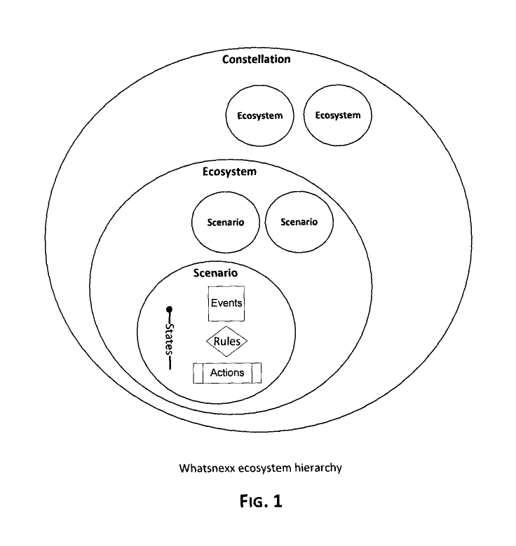

Referring first to FIG. 1, in the present embodiment, a scenario, or workflow, generally comprises several states in which the subject can be. A scenario is also used to describe all the possible flows for a subject in a state changing environment. A scenario is a mix between a state machine and a sequence diagram. A scenario consists of states, events, actions and conditions.

In a scenario, an event is a detectable trigger. An event is attached to a state and can be used by more than one state. Typically, events are information received by the system from either an external resource or from an internal resource. An event can be used to modify a subject's state, to feed or modify attributes, to trigger one or more actions, etc.

In the present embodiment, there are three broad types of events: 1) process with delay, 2) receive information and then process, and 3) process now. As it will be best understood below, the “process now” event starts when the focus changes or returns to the same state. The “receive information and then process” event starts when the scenario receives an event from an external system. Finally, the “process with delay” event starts when a predefine delay is triggered from the system.

For their part, the purpose of an action element is to define the action that an external system must execute on behalf of the subject or toward the subject in response to an event. The action supplies the appropriate resource such that the system can properly interact with an external system or resource for the action to be executed. For instance, the action will populated the appropriate fields of an XML ticket such that an email can be sent in response to an event (e.g. the customer has ordered an item).

Typically, but not necessarily, all actions are executed in parallel and are independent from each other. Multiple actions can be triggered by a single event as long as they are in the same process path.

For its part, a condition comprises a set of rules in association with an event. When an event is triggered on a state, the rule pipeline starts the process path of actions. The rule pipeline can comprise one or more logical rules and the rules can be more or less complex.

In the present embodiment, the condition is the last step where conditional changes (i.e. update attributes) can be applied before the execution of the action(s). This is typically the place to perform personalization since all context information for the ecosystem is accessible when evaluating the rules. When a rule is evaluated, context values can be modified whether the rule evaluates as true or false. In the present embodiment, the first rule that returns a true value halts the rule pipeline execution and the subsequent rules are ignored.

The different states are generally defined by the user. In a given scenario, the states are interconnected and a subject can change state in response to an event and according to more or less complex conditional logic. Action or actions can also be initiated in response to an event and also according to more or less complex conditional logic.

As a subject can be involved in different yet related scenarios, scenarios which are related are grouped into an ecosystem. In other words, an ecosystem is a group of scenarios that target the same subject type.

As the scenarios in an ecosystem are related, an event affecting a state in one scenario can trigger an action that will become an event in another scenario in the same or another ecosystem.

In a marketing environment, an ecosystem can be viewed as a campaign that has no predefined end date.

An ecosystem is also typically defined by its vocabulary. The vocabulary of the scenarios, including states, events, conditions, and actions, of the ecosystems, and of the constellation is typically created by the user. The vocabulary is about creating an abstract view of the user's world. For instance, marketers will use and define an ecosystem by using terms that reflect the marketing domain. These terms are used to define states, events, conditions, actions and resources. With this approach, the user can define and design his own vocabulary and start using these terms in his scenarios (ex. campaign, prospect, client, VIP, at risk, welcome email, etc.). The present embodiment of the system typically allows the user to define sophisticated vocabularies around specific domains, to save it and to reuse it other similar project. The present embodiment of the system even allows the user to package vocabularies and sell them.

As illustrated in FIG. 1, it is possible to have multiple ecosystems for the same subject. These multiple ecosystems are typically grouped into a single constellation.

Understandably, since the present invention revolves around the state of subject, it is important, before creating a scenario, to identify the subject the user wants to address or control in the ecosystem. The subject is an abstraction of the entity the user wants to address or control. As indicated above, there can be more than one ecosystem for the same subject type, e.g. a constellation. However, an ecosystem can only address a single type of subject.

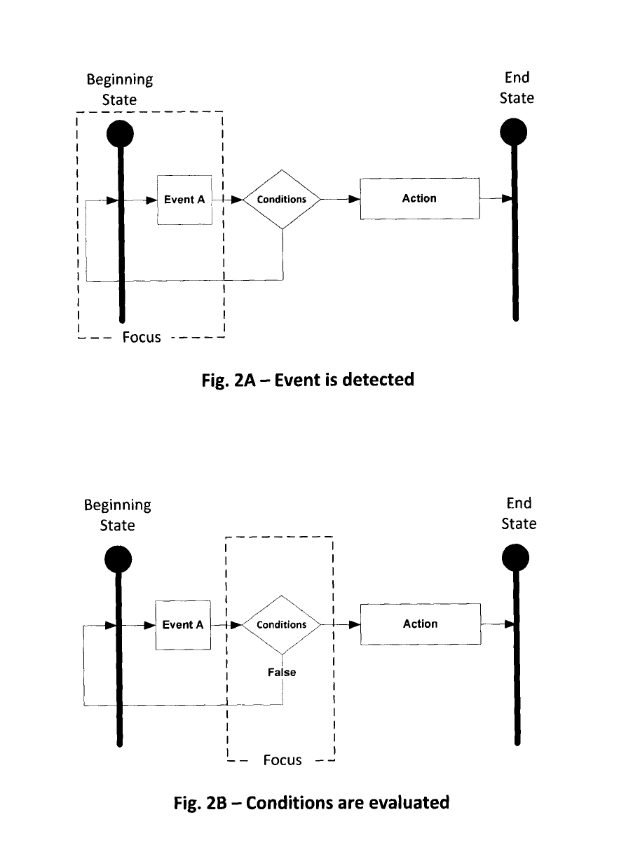

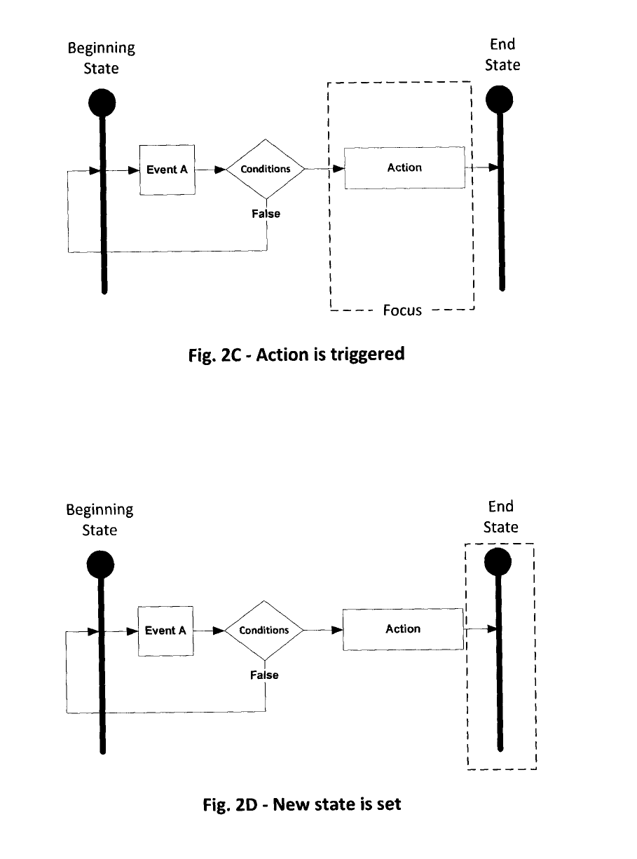

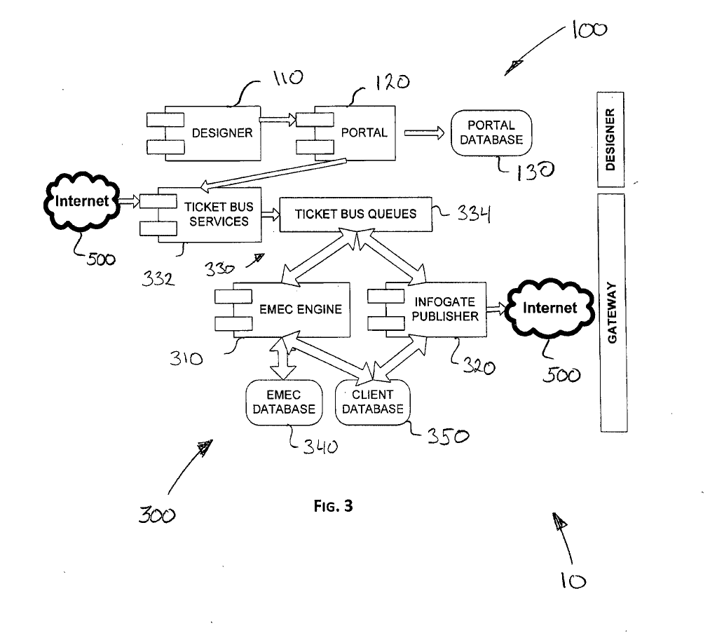

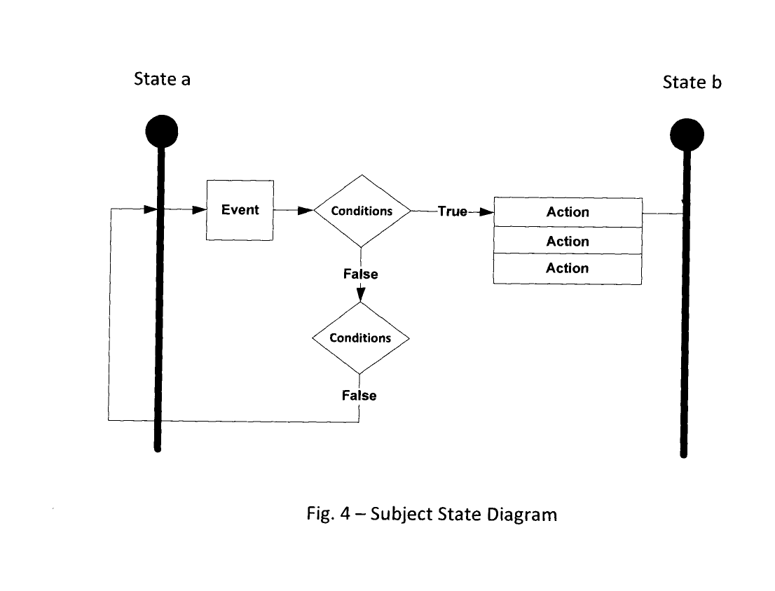

Referring to FIGS. 2A to 2D, a simple illustrative scenario is depicted.

Referring to FIG. 2A, the first element of a scenario is a state. The state generally represents the status of the subject (e.g. prospect, client, at risk, etc.). When a state is active, i.e. it currently has the focus, it listens for events associated with it.

In FIG. 2A, only one event is depicted. However, in more complex scenarios, several events could be associated with a state.

An event triggers a scenario, and can only trigger a scenario if it occurs while the subject remains focused on a state to which the event is relevant. Otherwise, the state ignores the event and the scenario is not initiated. Hence, in FIG. 2A, if the event that is occurring is not “Event A”, then the scenario will not be initiated.

Referring to FIGS. 2B and 2C, when an event does occur and when this event is relevant to the currently active state, e.g. “Event A”, the conditions or rules associated with that event will be evaluated and executed in sequence. As soon as a true condition is found, the flow will branch to the associated actions. If all rules are false, then the flow will return to the next state. In FIG. 2B, if the condition is false, the focus returns to the beginning state. Still, in more complex scenario, a false result could cause the scenario to branch to another state.

When the focus changes or returns to the same state, it re-triggers any action associated with landing on that state.

When changing state, as in FIG. 2C, all actions in the event process path are triggered.

Finally, referring to FIG. 2D, the end of an event process path is an end point connected to a state representing the new scenario state.

Understandably, scenarios can be more or less complex, contain scenario specific sub-states, pass subject attributes from scenario to scenario, and create events for other scenarios or ecosystems.

In the present embodiment, a state can have an unlimited number of events, events can have single or multiples rules, and can execute an unlimited number of actions. In other words, for a given state, one type of events could trigger one set of rules while another type of events could trigger another set of rules. For example, if the subject is a person and the current state is “client”, the event “buying for 100$ online” could trigger the transmission of an email while the event “buying for 1000$ online” could trigger the mailing a gift card.

In the present embodiment, actions can only have one entry point and one end point while states can have an unlimited number of entry points. In other words, several states can lead to the same state depending on the events and/or conditions.

When the focus moves to the end state, the scenario is complete.

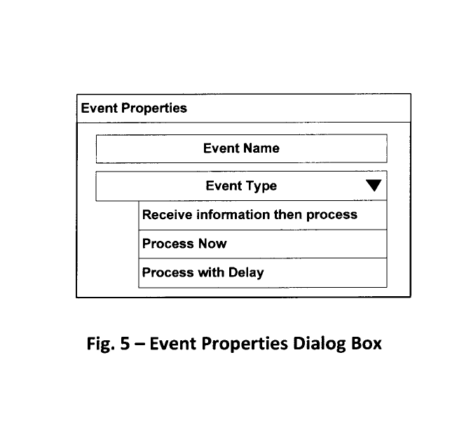

Referring now to FIG. 3, in the present embodiment, the system, generally identified at 10, comprises two main components, a designer module 100 and a gateway module 300.

The designer module 100 generally allows the user to create scenarios and ecosystems. In that sense, the designer module 100 is typically a computer-aided design (“CAD”) tool.

Typically, in the present embodiment, the creation process begins with the identification of the subject (e.g. customer) that the scenarios and ecosystems will address. The next step is to identify all of the possible states that the subject could be in (e.g. unknown, subscriber, client, at risk, VIP, etc.). Understandably, the design process is not necessarily linear; multiple iterations can be involved in the design of a scenario.

Once all or most of the possible subject states are identified, each is examined individually. For each state that the subject could be in, it is necessary to determine most and preferably all the possible detectable events that could happen and could be relevant to that state. The events are then defined and associated to the state.

At this point, it is important to note that the events relevant to each state are defined by the user and not by the system. It that sense, the system really allows the user to customize the scenarios to his particular needs.

Then, for each event identified, it is necessary to determine the action or actions that the user would like the system to take and the resulting state.

For example, when a contact (i.e. current state of a subject) buys (i.e. event), then send a “Thank You email” (i.e. action), and move the contact to a client state (i.e. resulting state).

Once all of the state/event/action combinations are identified, the next step is to identify any rules or conditions that could influence the action resulting from an event. For example, when the customer (i.e. state) buys (i.e. event) more than $1000 in life time sales (i.e. condition) then send him a gift card (i.e. action).

The result of this exercise is a clear identification of the subject states, events, actions and conditions that make up the subject's ecosystem. These are organized into scenarios that define strategies and tactics (e.g. acquisition, renewal, customer at risk) and are then entered in the diagramming tool 110 of the designer module 100.

The diagramming tool 110 of the designer module 100 typically consists of a computer user interface allowing the user to drag-and-drop and to connect state icons, arrows, event boxes, condition boxes, action boxes, etc. (i.e. scenario components or elements) such as to graphically design the scenario.

Typically, using the diagramming tool 110, the user will drag-and-drop state icons, event boxes, condition boxes and action boxes, and will then connect them, in accordance with the desired scenario.

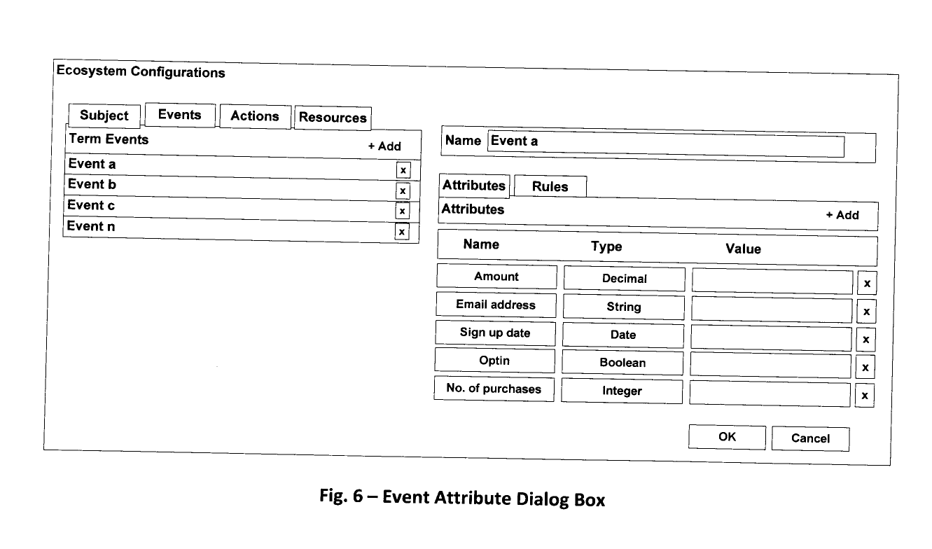

FIG. 4 is a screenshot of the diagramming tool 110 of the present system. On the right, the user can select the appropriate scenario component and drag it or place it on the design screen.

Also, by clicking (with a mouse or any other pointing device) on a scenario component, the user can populate, edit (with a keyboard or any other similar inputting device) or select the fields associated thereto. For instance, the user can name a state, described an event in an event box, enter the fields to be evaluated by a condition box, etc.

In that sense, the diagramming tool 110 typically comprises tool bars, drop-down menus, configuration windows, etc., as in known CAD interface, allowing the user to properly select, place, and edit the components of the scenarios on the screen.

For instance, in FIG. 5, the user has selected a “buys” event and a drop-down menu has appeared, allowing the user to select the appropriate type of event.

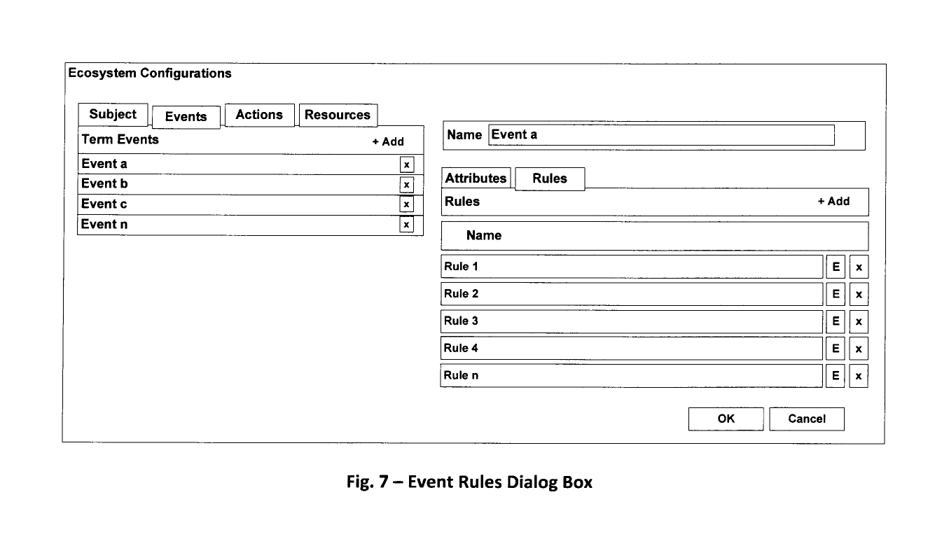

In FIGS. 6 and 7, the user has selected a “buys” event and a configuration window has appeared, allowing the user to modify the parameters of the “buys” event. In FIG. 6, the user has selected the “Attributes” tab such as to be able to edit the attributed of the “buys” event, while in FIG. 7, the user has selected the “Rules” tab such as to be able to edit the rules associated with the “buys” event.

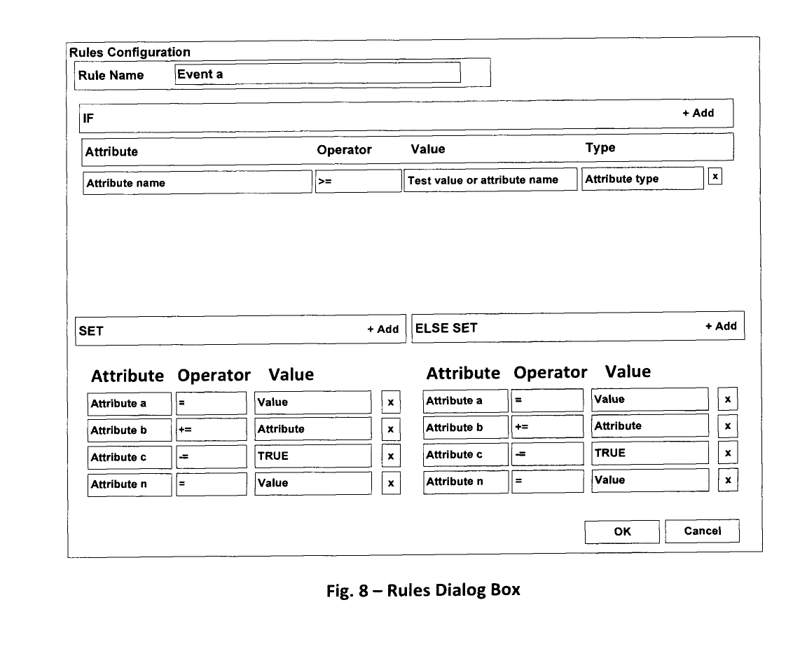

FIG. 8 shows a screenshot of a configuration window for a rule. The window allows the user to edit each of the rules associated with an event. In the present embodiment, the name of the rule, its attributes, and the subsequent attribute(s) modification can be entered and/or edited.

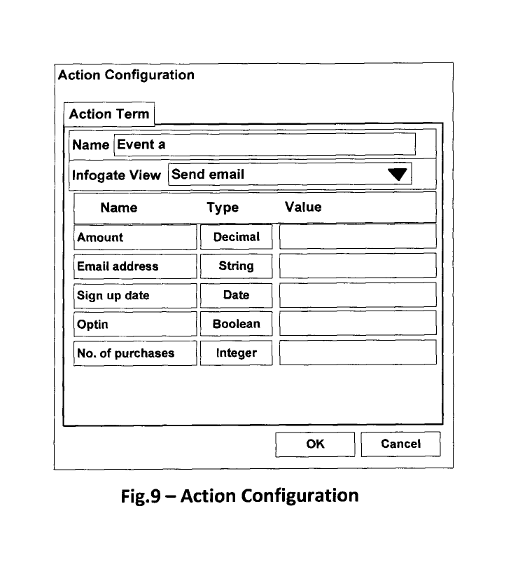

In FIG. 9, a screenshot of a configuration window for an action is shown. The window allows the user to edit each of the actions associated with the rules.

Once the scenarios are completed, the next step is to build the connector layer of the ecosystem. The connector layer consists of attributes or fields that are used by the ecosystem's scenarios for execution. Only the attributes required for the execution of the ecosystem need be considered.

For example, a scenario which manages post purchase communications might need the email address, the order number and the complete name of the purchaser so that this information can pass through to the email system.

In the present embodiment of the system, there are three types of attributes: 1) event attributes, i.e. data being passed to the system from an external resources (e.g. a networked database) or an internal resource; 2) subject attributes, i.e. information required to execute the scenarios (e.g. complete name, email address, etc.); and 3) resources attributes, i.e. constants used to access external resources.

Once the all the attributes are defined, the next step is to define and build the conditional rules that will govern some of the behavior of the scenario. The rules generally consist of more or less complex logical functions that use attributes to determine conditions (e.g. If number of sales=>5). Rules can be combined and they can control branching in the scenario.

For example, a first condition can branch into two subsequent conditions, and each of these subsequent conditions could involve different sets of actions and lead to different states.

The final step in building the ecosystem is to select and map the infogates.

An infogate is a configurable, intelligent bridging agent between the gateway module 300 and an external system or application. Infogates are required in order to execute scenario actions and events. An infogate is typically a pre-programmed routine that creates an XML ticket that can be sent to any application via a distributed computer network 500 (e.g. the Internet).

Infogates exist in the runtime side of the system 10.

When the user is designing a scenario, it will only have access to an infogate view (see FIG. 9). An infogate view presents only the information required in order to execute its function. The user therefore uses the infogate views to bind data from the ecosystem so that the external systems can perform their function properly.

Though an infogate can comprise several fields relative to a particular external resource, an infogate view will only show the field which can be customized by the user for a particular scenario.

For example, an infogate configured to access an email system will comprise static fields particular to the email system and custom fields such as the message to be sent and personalization data.

When using the designer module 100, only the custom fields are available for modification.

Referring back to FIG. 3, in the present embodiment, the gateway module 300 uses two different approaches. In the first approach, it is the gateway module 300 that initiates the communication to the external services. This approach is the simplest way to connect external services that offer a set of application programming interfaces (“API”) to allow data exchange. The second approach is to accumulate data and wait for external service to come pull the data. This approach allows external services that hide behind firewall while still be able to communicate with gateway module 300.

Infogates are stateless by nature. When they need to perform a job, they first load the right infogate view, perform their tasks, issue the XML tickets as required, and then discard the infogate view.

These XML tickets contain the address of the target system, and the other required information in order to be properly executed by the target system.

In the present embodiment, several infogates are already programmed to access several known external applications such as email. Still, the present embodiment of the system allows the user to create additional infogates for new or other external applications. These can be created using a standard programming language such as C#.

Hence, to complete the design of an ecosystem and its scenarios, the user simply has to select the appropriate infogate(s) from a list (see FIG. 9). Each selected infogate will present a list of attributes that need to be populated in order for the target system (e.g. email) to execute the given action. Then, it is a simple matter of mapping the appropriate subject and resource attributes against the infogate fields (e.g. email=EmailAddress, Fname=FirstName, etc.).

Understandably, depending on the complexity of the target external applications, the infogates can contain more or less fields.

At this point, the design process is typically complete and the next step is to publish the ecosystems to the portal 120 where they are stored in the portal database 130.

Once the ecosystems are in the portal 120, the user can transfer them to the gateway module 300.

The gateway module 300 is responsible for running and executing the ecosystems stored in its database.

In the present embodiment, the ecosystems designed via the designer module 100 can be tested on the gateway module 300 prior to being fully launched. These testing capabilities allow the user to see whether the scenarios respond properly to events. In that sense, the gateway module 300 allows the user to feed fictitious events in order to test the response of the scenarios, and to monitor the execution of actions according to the scenario rules.

Understandably, a malfunctioning scenario could result in unwanted consequences such as the repetitive transmission of emails.

To initiate the testing of ecosystems, the user transfers the ecosystems from the portal 120 to the staging environment of the gateway module 300.

Once an ecosystem is tested and considered to work properly, it can then be put in production on the gateway module 300. To that effect, the gateway module 300 will transform the ecosystems into a sequential workflow which will be sent to the ticket bus services 332 of the ticket bus 330 and stored on the ecosystem control (“EMEC”) database 340.

In production, the ecosystem will begin to process event XML tickets as they are received from other scenarios or from external resources connected to the distributed computer networks 500 (e.g. Internet), and will issue action XML tickets as required by the scenario rules.

It is to be understood that in the present embodiment, one scenario can launch actions that will be events in other scenarios within and without the ecosystem, leading to chains of events and actions. For instance, a customer order scenario can launch an order tracking scenario in another ecosystem. Scenarios and ecosystems can be designed to work individually or in concert to model complex behavior. Hence, a scenario could generate an event XML ticket to trigger an event in another scenario.

The gateway module 300 essentially works as follows. When an event XML ticket is received, it is stored on the ticket bus queues 334 of the ticket bus. The ticket bus queues 334 generally comprise an EMEC queue and an infogate queue.

Tickets stored on the EMEC queue will be processed by the EMEC engine 310. The EMEC engine 310 is the heart of the gateway module 300. First, it processes ecosystem files published by authenticated user of the designer module 100. As seen earlier, an ecosystem file produced by the designer module 100 contains the subject definition, vocabulary terms and scenarios (including events, conditions, and actions). The EMEC engine 310 creates the live constellation from this data, if applicable (see FIG. 1). The ecosystems or constellations need to access a lot of functionality that is outside of its asynchronous world.

As the EMEC engine 310 processes an XML ticket from the EMEC queue, it will first identifies the correct subject and then looks at each scenario in the ecosystem associated to that subject. If the event appears in a scenario, then the EMEC engine 310 will evaluate if the subject is in a state that listens for that particular event.

If yes, then the EMEC engine 310 will evaluate to associated conditions and, if appropriate, it will issue a properly populated a XML ticket in accordance to the action that needs to be executed. In that sense, the EMEC engine 310 will send the new XML ticket to the infogate queue. Otherwise, the EMEC engine 310 will move on to the next scenarios in the ecosystem.

For their part, the XML tickets stored on the infogate queue are processed by the infogate publisher 320. The infogate publisher 320 is responsible for transforming the XML tickets, the tickets issued by the EMEC engine 310 and processed by the ticket bus 330, using predetermined mapper with external service. The infogate publisher 320 is responsible for executing the call, and for managing the communication process with external services using the infogate components. Hence, the infogate publisher 320 receives XML tickets waiting on the infogate queue, processes them and sends them to external services (on the distributed computer network 500) or store them on the client database 350.

Infogates components are responsible for engaging a dialogue with external networked resources. This dialogue is shielded from activity on the ticket bus 330. The implementation is different for each type of infogate. Infogates merges data from a scenario with the configuration of an infogate, and interacts with an external system, typically via a Web Service Definition Language (“WSDL”) and the Simple Object Access Protocol (“SOAP”) envelope.

Once all of the scenarios are reviewed, the EMEC engine 310 will process the next event XML ticket it receives.

The EMEC engine 310 provides multiple server side components to the ecosystems state management. Aside from constellation persistence and caching, the engine 310 does not archive any information on resources. It only keeps the abstraction of the resource in vocabulary term format. Every piece of data needed to carry the different actions is requested from infogates.

The EMEC engine 310 typically uses a sequential workflow though the logic could be a state workflow as in the present embodiment.

In use, when the scenarios (i.e. workflows) have been properly defined and designed using the designer module 100 and that they have been properly tested on the gateway module 300, the scenarios are launched for operation.

When launched, each of the scenarios will have a current state and will wait for events to occur.

As events occur on external or internal resources, the gateway module 300 will receive event XML tickets on the EMEC queue. Each of these event tickets will be processed by the EMEC engine 310 and checked against each of the scenario in order to determine if the event is relevant to the current state.

If the event is found to be relevant, the EMEC engine 310 will process the conditions, issue the appropriate action XML ticket or tickets to the infogate queue, and change the state if necessary.

The EMEC engine 310 will then process the next event ticket.

The skilled addressee will understand that the present embodiment of the system in accordance with the present invention allows more flexibility in the creation and execution of subject-state-based workflows.

By allowing the user to define the subject and define the states, the triggering events, the conditions, and the actions, the present embodiment of the system in accordance with the present invention allows the user to create workflow tailored to its particular needs.

In addition, by allowing the workflows to interact with internal and, more importantly, external resources, the present embodiment of the system in accordance with the present invention allows the user to deploy the workflows in a true distributed computer environment.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1) A method for creating a subject-state-based workflow relating to a subject, the method comprising:
placing state elements in a design window;
placing event trigger elements in the design window;
placing condition elements in the design window;
placing action elements in the design window;
in the design window, connecting each one of the event trigger elements to only one of the states;
in the design window, connecting each one of the condition elements to only one of the even trigger elements;
in the design window, connecting each one of the action elements either to only one of the event trigger elements or to only one of the condition elements;
in the design window, connecting each one of the state elements to at least one of the event trigger elements, of the condition elements, and/or of the action elements of at least another one of the state elements;
editing each of the state elements such that each of the state elements corresponds to a different state of the subject;
editing each of the event trigger elements such that each of the event trigger elements corresponds to a determined event;
editing each of the condition elements such that each of the condition elements comprises at least one logical operation to be evaluated;
editing each of the action elements such that each of the action elements comprises at least one action to be executed.

2) A method as claimed in claim 1, wherein the state elements, the event trigger elements, the condition elements and the action elements have different graphical representations.

3) A method as claimed in claim 1, wherein the placing steps and the connecting steps are effected using a pointing device.

4) A method as claimed in claim 1, wherein the design window is displayed on a display device of a computer system.

5) A computer-readable medium containing instructions for controlling at least one computer system to allow a user to perform a method for creating a subject-state based workflow relating to a subject, the method comprising:
placing state elements in a design window;
placing event trigger elements in the design window;
placing condition elements in the design window;
placing action elements in the design window;
in the design window, connecting each one of the event trigger elements to only one of the states;
in the design window, connecting each one of the condition elements to only one of the even trigger elements;
in the design window, connecting each one of the action elements either to only one of the event trigger elements or to only one of the condition elements;
in the design window, connecting each one of the state elements to at least one of the event trigger elements, of the condition elements, and/or of the action elements of at least another one of the state elements;
editing each of the state elements such that each of the state elements corresponds to a different state of the subject;
editing each of the event trigger elements such that each of the event trigger elements corresponds to a determined event;
editing each of the condition elements such that each of the condition elements comprises at least one logical operation to be evaluated;
editing each of the action elements such that each of the action elements comprises at least one action to be executed.

6) A computer-readable medium as claimed in claim 5, wherein the design window is displayed on a display device of the computer system.

7) A method to execute on a computer system subject-state-based workflows relating to a subject, each of the workflows comprising states, each of the states comprising at least one event trigger, optionally at least one condition associated to the at least one event trigger, and optionally at least one action associated to the at least one event trigger or to the optional at least one condition, each of the workflows having a current state, the method comprising:
a) receiving an event ticket from the computer system or from an external distributed computer network;
b) comparing the event ticket to the at least one event trigger associated with each of the current states of each of the workflows;
c) for each of the current states of each of the workflows, if the event ticket corresponds to the at least one event trigger associated therewith, processing the at least one condition, if any, and the at least one action, if any, associated with the event trigger;
d) for each of the processed actions, issuing at least one action ticket in accordance with the action;
e) for each of the current states of each of the workflows, changing the current state to a new current state or returning to the existing state;
f) repeating steps a) to e) for each subsequent event ticket.

8) A system in accordance with the principles of the present invention.

9) A method in accordance with the principles of the present invention.
